(19) United States
(12) Patent Application Publication
(10) Pub. No.: US 2004/0010329 A1
(43) Pub. Date: Jan. 15, 2004

(54) Method for reducing buffer requirements in a digital audio decoder

(75) Inventors: Chung-Hsien Lee, Kaohsiung Hsien (TW); Hsin-Yi Huang, Kaohsiung (TW)

Correspondence Address: MERCHANT & GOULD PC, P.O. BOX 2903, MINNEAPOLIS, MN, 55402-0903, US

(73) Assignee: Silicon Integrated Systems Corp.

(21) Appl. No.: 10/191,223

(22) Filed: Jul. 9, 2002

(51) Int. Cl. G06F 17/00

(52) U.S. Cl. 700/94

(57) ABSTRACT

A method for reducing buffer requirements in a digital audio decoder. Firstly, N samples that have to be decoded for an audio channel at this time are extracted from a sub-frame of a bitstream. A sub-block of K PCM samples is calculated at a time by performing an inverse transform on the N extracted samples, and then the N extracted samples are discarded. Note that the number of extracted samples is greater than or equal to the number of the PCM samples in a generated sub-block, i.e., N≧K. The above steps are repeated until one PCM output sub-frame of the audio channel is fully obtained.

### BACKGROUND OF THE INVENTION

1. Field of the Invention

The invention relates to digital audio decoding. More particularly, the invention relates to a scheme for reducing buffer requirements in a digital audio decoder.

2. Description of the Related Art

In the past several years, digital audio data compression has become an important technique in the audio industry. Various standards have been introduced that allow high quality audio reproduction without the need for the data bandwidth that would be required using traditional techniques. Digital audio/video compression standards known as “MPEG” (for Moving Picture Experts Group) were promulgated by the International Standards Organization (ISO). In the first phase of MPEG, a compression standard for two-channel stereo audio was developed that gives near Compact Disk (CD) quality. MPEG-2 denotes the second phase of MPEG. For two-channel stereo, the differences between MPEG-1 and MPEG-2 are minor. The most substantial change in MPEG-2 is the definition of a compression standard for multichannel coding. A variety of compression schemes are possible in both MPEG-1 and MPEG-2 audio. Both MPEG-1 and MPEG-2 audio, for example, provide three compression techniques, referred to as “layers”, of increasing compression quality and decoder complexity. The most widely used audio compression formats are Layers 2 and 3. In particular, the MPEG Layer-3 (a.k.a. MP3) has emerged as the main format for Internet audio delivery. Additionally, MPEG-2 Advanced Audio Coding (AAC) was developed as the successor for MPEG-1 Audio. AAC is a second generation audio coding scheme for generic coding of stereo and multichannel signals.

The Advanced Television System Committee (ATSC) adopted a competing standard known as “AC-3” as the audio service standard for High Definition Television (HDTV). AC-3 has also found applications in consumer media such as Digital Video Disc (DVD) and direct satellite broadcast. An AC-3 bitstream is composed of frames representing a constant time interval of 1536 PCM samples across all coded channels. Within each frame are six audio blocks, each representing 256 PCM samples per coded channel. The AC-3 audio decoding technology requires certain steps such as bit allocation, dequantization, decoupling, rematrixing, dynamic range compression, and inverse Modified Discrete Cosine Transform (MDCT). On the other hand, each MP3 audio frame containing two granules represents 1152 samples of input PCM audio. A granule in MP3 can be viewed as consisting of 18 samples in each of 32 subbands, for a total of 576 samples. For decoding MP3 bitstream, it requires certain steps such as variable length decoding of audio samples, decoding of scale factors and bit allocation, dequantization of samples, computation of inverse MDCT, and synthesis of subband samples.

To reconstruct digital audio, prior art solution provides a large memory buffer capacity for storing all channels in a frame simultaneously such that a decoder can transform the audio signal from frequency to time domain. In the example of AC-3 bitstream decoding, an input buffer for performing an IMDCT with 50% overlap requires 512×6=3072 samples, and an output buffer for the IMDCT requires 256×6=1536 PCM samples. Likewise, a prior art MP3 decoder requires an input buffer of 576×2=1152 samples to perform an IMDCT with 50% overlap, requires a synthesis input buffer of 576×2=1152 samples to perform subband synthesis, and requires an output buffer of 576×2=1152 PCM samples. Although simple to implement in principle, this scheme is excessive in terms of size, cost and complexity in a digital audio decoder that is implemented on a single integrated circuit chip. Accordingly, what is needed is a digital audio decoder with greatly reduced buffer requirements compared to the prior art.

### SUMMARY OF THE INVENTION

It is an object of the present invention to provide a scheme for reducing buffer requirements in a digital audio decoder.

The present invention is generally directed to a method for reducing buffer requirements in a digital audio decoder of a plain transform-based coding system. According to one aspect of the invention, N samples that have to be decoded for an audio channel at this time are extracted first from a sub-frame of a bitstream, where N is a first predetermined number and a positive integer. Then, the N extracted samples are stored to a first buffer having sufficient capacity for the N extracted samples. An inverse transform is performed on the N extracted samples in the first buffer to generate a sub-block of K PCM samples at a time. Subsequently, the just generated sub-block is stored to a second buffer having sufficient capacity for the K PCM samples. Note that the sub-block constitutes a portion of a PCM output sub-frame in which K is a second predetermined number, where N≧K and K is a positive integer. Thereafter, the N extracted samples are discarded. Hence, the above steps are repeated to fully obtain one PCM output sub-frame of the audio channel.

According to another aspect of the invention, a method for reducing buffer requirements in a digital audio decoder employing a hybrid filterbank is disclosed. The first step of the inventive method is to extract N samples that have to be decoded for an audio channel from a sub-frame of a bitstream in which the sub-frame includes M samples. Then the N extracted samples are stored to a first buffer having sufficient capacity for the N extracted samples. Note that N is a first predetermined number, M is a second predetermined number, where M≧N and M, N are positive integers. An inverse transform is performed on the N extracted samples in the first buffer to generate at least one subband sample at a time. Subsequently, the subband sample is stored to a second buffer having sufficient capacity for K subband samples, where K is a third predetermined number and a positive integer. Thereafter, the N extracted samples are thrown away. The above steps are repeated until the K subband samples of the audio channel are fully obtained. Once all of the K subband samples are stored in the second buffer, they are applied to a synthesis filterbank including K subbands. Meanwhile, a block of PCM output samples is reconstructed with the synthesis filterbank.

### BRIEF DESCRIPTION OF THE DRAWINGS

The present invention will be described by way of exemplary embodiments, but not limitations, illustrated in the accompanying drawings in which like references denote similar elements, and in which:

FIG. 1A is a block diagram of a plain filterbank useful in understanding the AC-3 coding system;

FIG. 1B is a block diagram of a hybrid filterbank useful in understanding the MPEG Layer-3 coding system;

FIG. 2A is a preferred embodiment for MPEG Layer-3 decoding in accordance with the invention;

FIG. 2B is a flowchart illustrating the operation of FIG. 2A;

FIG. 3A is an alternative preferred embodiment for AC-3 decoding in accordance with the invention; and

FIG. 3B is an alternative flowchart illustrating the operation of FIG. 3A.

### DETAILED DESCRIPTION OF THE INVENTION

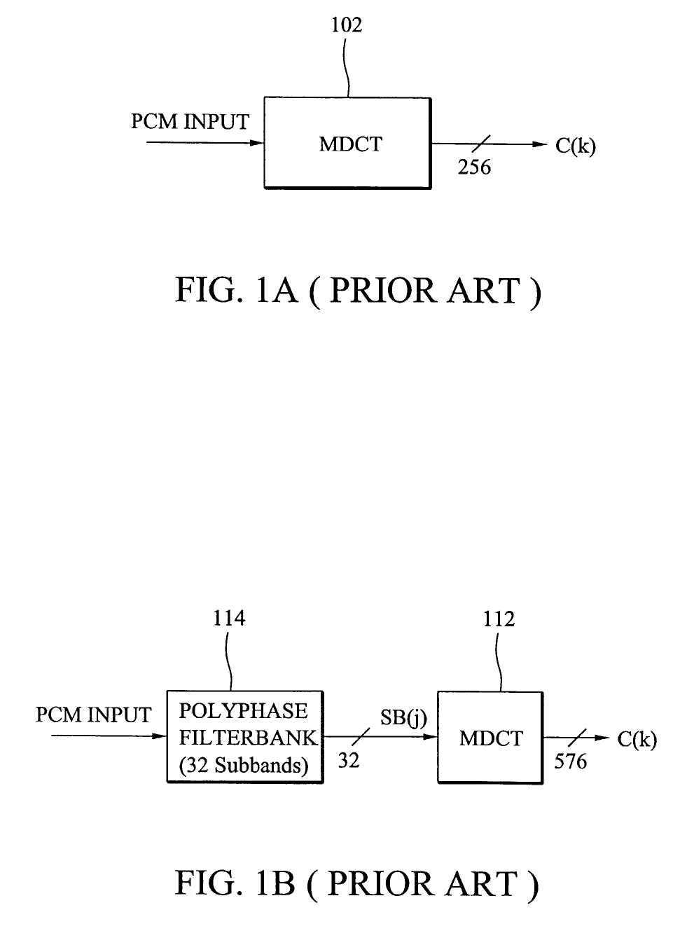

As the present invention preferably implements portions of the MPEG and AC-3 audio decoding algorithms, a key technology in their encoding, e.g. time-frequency mapping, will now be briefly described with reference to FIGS. 1A and 1B. MPEG and AC-3 both are the perception-based coders employing frequency domain coding. A time-frequency mapping (a filterbank or the like) is used to decompose the input signal into subsampled spectral components. Together with the corresponding filterbank in the decoder (frequency-time mapping) it can form an analysis/synthesis system. All perception-based coders use the same basic structure. The encoder analyzes the spectral components of the audio signal by calculating a filterbank (transform) and applies a psychoacoustic model to estimate the just noticeable noise-level. In its quantization and coding stage, the encoder tries to allocate the available number of data bits in a way to meet both the bitrate and masking requirements.

AC-3 uses purely Modified Discrete Cosine Transform (MDCT) for coding. As shown in FIG. 1A, the AC-3 encoder uses a 512-point MDCT with 50% overlap. The PCM input samples are applied to the filterbank 102 to generate 256 frequency components C(k)_{k=0 255} per audio block. In the event of transient signals, improved performance is achieved by using a block-switching technique, in which two 256-point transforms are computed in place of the 512-point transform. The MDCT is a linear orthogonal lapped transform, based on the idea of time domain alias cancellation (TDAC).

Referring now to FIG. 1B, the filterbank used in MPEG Layer-3 is a hybrid filterbank which consists of a polyphase filterbank 114 and a MDCT 112. This hybrid form was chosen for reasons of compatibility to its predecessors, Layer-1 and Layer-2. The digital audio signal (PCM input) is first split into 32 subband signals SB(j)_{j=0 . . . 31} using the polyphase filterbank 114. The subbands are equally spaced in the frequency domain from 0 HZ to half the rate at which the original signal was sampled. In order to achieve a higher frequency resolution closer to “critical band” of human hearing, the 32 subband signals SB(j)_{j=0 . . . 31} are subdivided further in frequency content by applying a 6-point or 18-point MDCT block transform with dynamic window switching. The subdivision of each subband into 18 finer frequency components amounting to a total of 576 frequency components C(k)_{k=0 . . . 575} increases the potential for redundancy removal, leading to better coding efficiency for tonal signals. The MDCTs can be switched to generate for each subband either 6 frequency components (called short-window MDCTs) or 18 frequency components (called long-window MDCTs). Note that the MDCT is a 50% overlapped transform. Thus, it is actually a 12-point or a 36-point transform, respectively. In contrast to the hybrid filterbank of MPEG Layer-3, MPEG-2 AAC uses a plain MDCT block transform that is similar to AC-3. For example, the filterbank in AAC coder is a 1024 line MDCT with 50% overlap (window length of 2048 samples). The filterbank is capable of switching to eight 128 line MDCTs (window length of 256 samples). Hence, the number of frequency lines in AAC is up to 1024 compared to 576 for Layer-3.

The decoding process is straightforward and just a reversal of the encoding process. Its only task is to synthesize an audio signal out of the coded spectral components. The present invention exploits the fact that an encoded audio frame comprises sub-frames or audio blocks of integrally encoded data. It is possible to decode MPEG or AC-3 bitstream using buffer memories that store just the needed samples for inverse transform, rather than an entire frame as in the prior art. The invention attempts to extract useful data from the bitstream only when the computation of inverse transform needs the data. In order to minimize the buffer requirements, the coded channels are processed one-at-a-time.

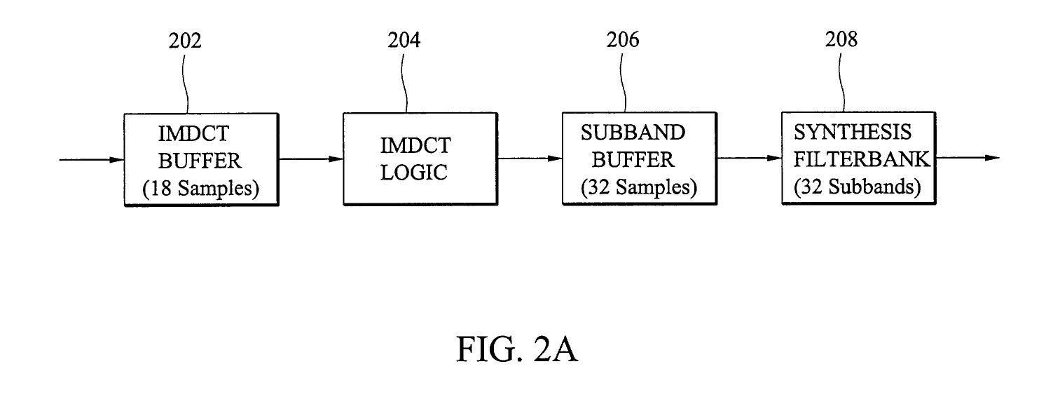

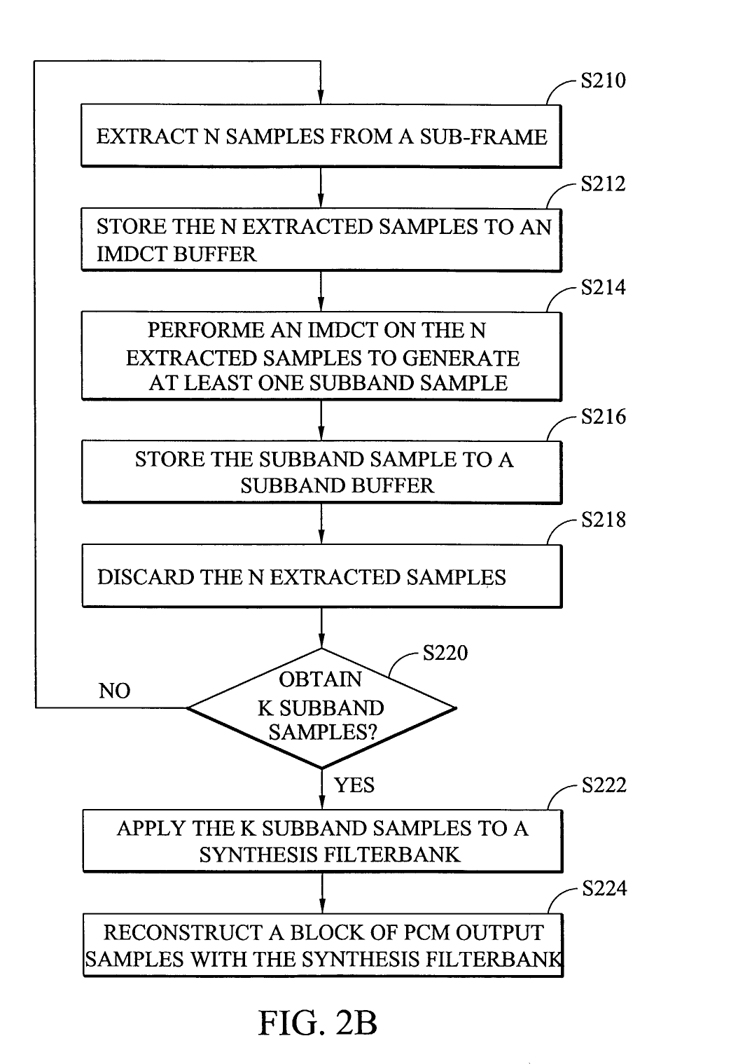

The inventive method for MPEG Layer-3 will be explained from a preferred embodiment of FIG. 2A in conjunction with the accompanying flowchart of FIG. 2B. At a step S210, N samples that have to be decoded for an audio channel are extracted from a sub-frame of an MP3 bitstream in which the sub-frame (granule) includes M samples. Note that N is a first predetermined number, M is a second predetermined number, where M≧N and M, N are positive integers. In one embodiment, M is equal to 576 and N is equal to 18 with respect to MP3. Then, at a step S212, the N (N=18) extracted samples are stored to an IMDCT buffer 202 having sufficient capacity for the N extracted samples. With IMDCT logic 204 at a step S214, an inverse transform is performed on the N (N=18) extracted samples in the IMDCT buffer 202 to generate at least one subband sample at a time. Subsequently, at step S216, the subband sample is stored to a subband buffer 206 having sufficient capacity for K subband samples, where K is a third predetermined number. In one embodiment, the third predetermined number K is equal to 32. Thereafter, at step S218, the 18 extracted samples are discarded, allowing storage of new samples. At a step S220, the steps S210˜S218 are repeated until the 32 subband samples of the audio channel are fully obtained. Once all of the 32 subband samples are stored in the subband buffer 206, they are applied to a synthesis filterbank 208 including K (K=32) subbands at a step S222. Meanwhile, a block of PCM output samples is reconstructed with the synthesis filterbank 208 at a step S224. In this way, each time the subband samples of all 32 subbands have been inverse-transformed, they are applied to the synthesis filterbank 208, and thus consecutive PCM output samples are generated.

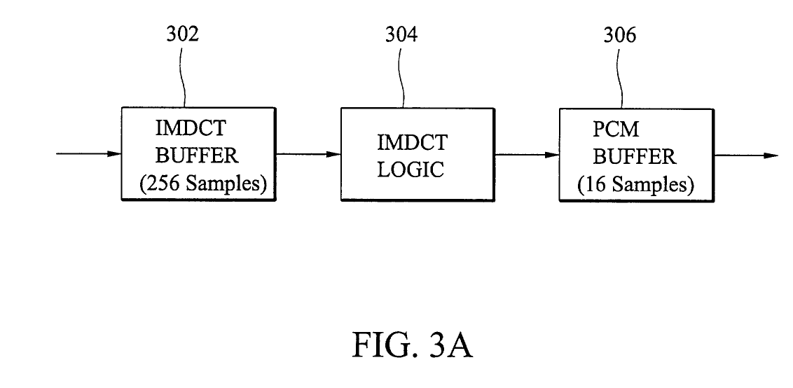

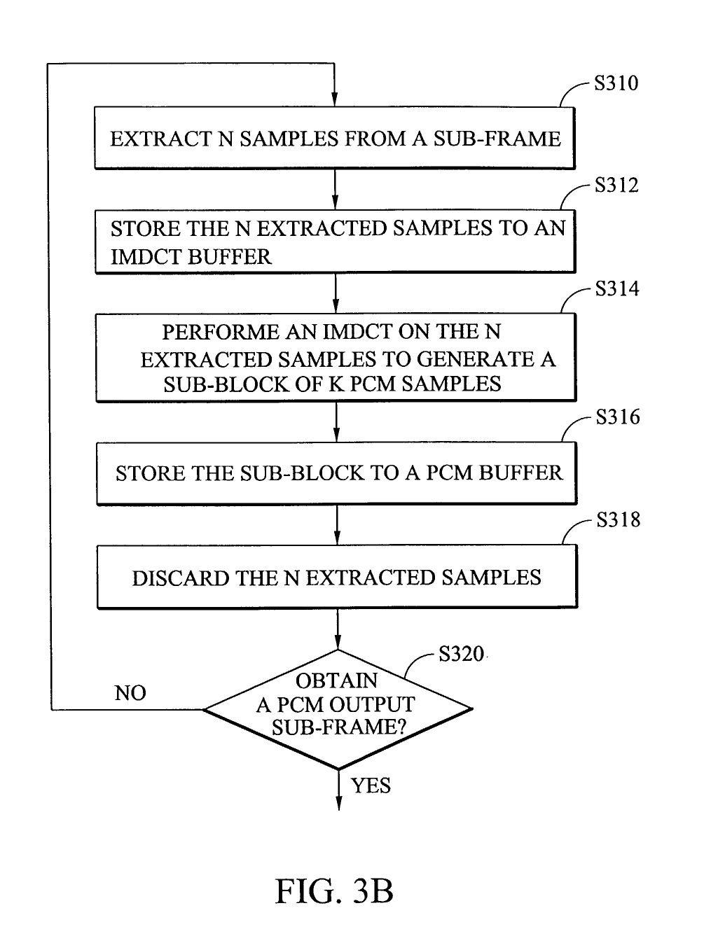

Turning now to the process for AC-3 decoding, an alternative embodiment of the invention is shown in FIG. 3A and its accompanying flowchart is detailed in FIG. 3B. The process for AC-3 is similar to the process for MPEG Layer-3 without the use of a synthesis filterbank. At a step S310, N samples that have to be decoded for an audio channel at this time are extracted from a sub-frame (audio block) of an AC-3 bitstream where N is a first predetermined number and a positive integer. Then, at a step S312, the N extracted samples are stored to an IMDCT buffer 302 having sufficient capacity for the N extracted samples. With IMDCT logic 304 at a step S314, an inverse transform is performed on the N extracted samples in the IMDCT buffer 302 to generate a sub-block of K PCM samples at a time. Subsequently, at a step S316, the just generated sub-block is stored to a PCM buffer 306 having sufficient capacity for the K PCM samples. Note that the sub-block constitutes a portion of a PCM output sub-frame (audio block) in which K is a second predetermined number, where N≧K and K is a positive integer. Thereafter, at a step S318, the N extracted samples in the IMDCT buffer 302 are discarded to store new samples. Thus, at a step S320, the steps S310˜S318 are repeated to fully obtain one PCM output sub-frame of the audio channel. The process continues, with the next sub-frames being extracted and inverse-transformed for reconstruction. Since N is a power of two for AC-3, the relationship between the first predetermined number N and the second predetermined number K is defined by:

$$K = \frac{N}{{2}^{n}}$$

where n≧0 and n is an integer. In one embodiment, the first predetermined number N is equal to 256 and the second predetermined number K is 16 (i.e., n=4).

Although the present invention is described with reference to the MPEG Layer-3 and the AC-3 standards, the invention is not limited, and can be applied to MPEG-2 AAC standard, as well as to encoding schemes other than MPEG and AC-3. Therefore, the invention fills a need that has existed in the art by providing a scheme with greatly reduced buffer requirements compared to the prior art.

While the invention has been described by way of example and in terms of the preferred embodiment, it is to be understood that the invention is not limited to the disclosed embodiment. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for reducing buffer requirements in a digital audio decoder, comprising the steps of:
(a) extracting N samples that have to be decoded for an audio channel at this time from a sub-frame of a bitstream, wherein N is a first predetermined number and a positive integer;
(b) storing the N extracted samples to a first buffer having sufficient capacity for the N extracted samples;
(c) performing an inverse transform on the N extracted samples in the first buffer to generate a sub-block of K PCM samples at a time, wherein the sub-block constitutes a portion of a PCM output sub-frame, wherein K is a second predetermined number where N≧K and K is a positive integer;
(d) storing the sub-block to a second buffer having sufficient capacity for the K PCM samples;
(e) discarding the N extracted samples; and
(f) repeating the steps (a)˜(e) until the PCM output sub-frame of the audio channel is fully obtained.

2. The method as recited in claim 1 wherein the bitstream conforms to the AC-3 specification.

3. The method as recited in claim 2 wherein the inverse transform is an inverse modified discrete cosine transform (IMDCT).

4. The method as recited in claim 2 wherein the first predetermined number N is equal to 256.

5. The method as recited in claim 2 wherein the relationship between the first predetermined number N and the second predetermined number K is defined by:
$$K = \frac{N}{{2}^{n}}$$
where n≧0 and n is an integer.

6. The method as recited in claim 1 wherein the bitstream conforms to the MPEG-2 Advanced Audio Coding (AAC) standard.

7. The method as recited in claim 6 wherein the inverse transform is an inverse modified discrete cosine transform (IMDCT).

8. A method for reducing buffer requirements in a digital audio decoder, comprising the steps of:
(a) extracting N samples that have to be decoded for an audio channel at this time from a sub-frame of a bitstream in which the sub-frame includes M samples, wherein N is a first predetermined number, M is a second predetermined number, where M≧N and M, N are positive integers;
(b) storing the N extracted samples to a first buffer having sufficient capacity for the N extracted samples;
(c) performing an inverse transform on the N extracted samples in the first buffer to generate at least one subband sample at a time;
(d) storing the subband sample to a second buffer having sufficient capacity for K subband samples, wherein K is a third predetermined number and a positive integer;
(e) discarding the N extracted samples; and
(f) repeating the steps (a)˜(e) until the K subband samples of the audio channel are fully obtained.

9. The method as recited in claim 8 further comprising the steps of:
(g) applying the K subband samples stored in the second buffer to a synthesis filterbank including K subbands; and
(h) reconstructing a block of PCM output samples with the synthesis filterbank.

10. The method as recited in claim 9 wherein the bitstream conforms to the MPEG layer-3 (MP3) format.

11. The method as recited in claim 10 wherein the inverse transform is an inverse modified discrete cosine transform (IMDCT).

12. The method as recited in claim 10 wherein the first predetermined number N is equal to 18.

13. The method as recited in claim 10 wherein the second predetermined number M is equal to 576.

14. The method as recited in claim 10 wherein the third predetermined number K is equal to 32.

15. The method as recited in claim 14 wherein the synthesis filterbank includes 32 subbands.
